(19) United States
(12) Patent Application Publication
(10) Pub. No.: US 2004/0190408 A1
(43) Pub. Date: Sep. 30, 2004

(54) Data recording control device

(76) Inventors: Takuya Shiraishi, Higashiosaka-shi (JP); Shin-ichiro Tomisawa, Mizuho-shi (JP)

Correspondence Address: FISH & RICHARDSON PC, 225 FRANKLIN ST, BOSTON, MA, 02110, US

(21) Appl. No.: 10/777,784

(22) Filed: Feb. 12, 2004

(30) Foreign Application Priority Data
Feb. 12, 2003 (JP) 2003-033889

(51) Int. Cl. G11B 7/00

(52) U.S. Cl. 369/47.1

(57) ABSTRACT

A compact device capable of recording data to at least DVD−R/RW and DVD+R/RW media. When an optical disc is a DVD−R/RW, an LPP address decoder generates an LPP address representing an irradiation position of a laser on the optical disc. When the optical disc is a DVD+R/RW, an ADIP address decoder generates an ADIP address representing an irradiation position of a laser on the optical disc. A selector selects either the LPP address decoder or the ADIP address decoder in accordance with the type of optical disc. A timing control circuit controls the timing of data recording in correspondence to an operation clock signal generated in accordance with the type of the optical disc.

### CROSS-REFERENCES TO RELATED APPLICATIONS

This application is based upon and claims the benefit of priority from prior Japanese Patent Application No. 2003-33889 filed on Feb. 12, 2003, the entire contents of which are incorporated herein by reference.

### BACKGROUND OF THE INVENTION

The present invention relates to a device for controlling the recording of data on various types of disc recording media, on which disc positional information of a predetermined data format is recorded, with a recording format that differs between each type of disc recording media.

Recently, multiple disc-type recording media such as in optical discs are becoming more popular. Disc recording media, such as for example, a Digital Versatile Disc−Recordable (DVD−R), a Digital Versatile Disc−ReWritable (DVD−RW), a Digital Versatile Disc+Recordable (DVD+R) and a Digital Versatile Disc+ReWritable (DVD+RW) have been introduced to the market. Although the format of the data recorded on the disc recording medium is the same in these disc recording media, the recording format of the disc positional information in DVD−R and DVD−RW media differs from that in DVD+R and DVD+RW media. DVD−R and DVD−RW meida (hereinafter referred to as DVD−R/RW) and DVD+R and DVD+RW media (hereinafter referred to as DVD+R/RW) are standardized disc recording media for recording data in compliance with the same data format, as shown in FIG. 4.

FIG. 4 shows the configuration of one sector of the recording data in a DVD. The DVD data to be recorded on the DVD disc medium consists of 32 bits of synchronizing signal (SYNC in FIG. 4) and 1456 bits of modulated data. In other words, 728 bits of data are 8-16 modulated to produce 1456 bits of data, and 32 bits of a synchronizing signal (SYNC) are added to the head of each of the 1456 bits of modulated data. This generates one frame of the recording data. In a DVD, 26 frames of the recording data make up one sector.

The recording format of the disc positional information recorded on the DVD disc medium differs depending on the type of the DVD disc medium.

The DVD−R/RW is provided with a track formed by a groove, which is formed in a flat surface (land) of the disc. The groove is formed so as to meander at a rate of sixteen cycles for every two frames of a data recording region in the above data format. A wobble signal having a predetermined cycle is extracted from such meandering (wobble) of the groove.

Further, the DVD−R/RW has, in addition to the wobble, a Land Pre-Pit (LPP), which represents disc positional information on the track and which is provided at predetermined intervals. The LPP is provided for every two frames of the data recording region having the above data format. A group of the LPPs that are provided for each of sixteen sectors of the recording region having the above data format represent positional information of the disc.

The DVD+R/RW is also provided with a track formed by a groove, which is formed in a flat surface (land) of the disc. A wobble signal having a predetermined cycle is extracted from the meandering (wobble) of the groove. The meandering cycle of the DVD+R/RW groove is longer than the meandering cycle of the DVD−R/RW groove. The DVD+R/RW groove meanders at a rate of 93 cycles for every two frames of a data recording region having the above data format.

There are no LPPs formed on the DVD+R/RW. In place of the LPP, the groove is formed so that phase-modulation is performed on the wobble signal of the predetermined cycle in accordance with disc positional information, which is referred to as Address In Pregroove (ADIP). More specifically, the wobble is phase-modulated once for every two frames of the data recording region having the above data format. The ADIPs acquired from each of four sectors of the recording region having the above data format represent the disc positional information.

In this manner, the recording format of the disc positional information differs between DVD−R/RW and DVD+R/RW. Thus, a conventional data recording control device compatible to both DVD−R/RW and DVD+R/RW is provided with a circuit used exclusively for DVD−R/RW and a circuit used exclusively for DVD+R/RW, as shown in FIG. 1,

The writing of data when an optical disc 301 is a DVD−R/RW or DVD+R/RW will now be described. First, an optical head 310 picks up a signal from the optical disc 301. An LPP detection circuit 320 generates an LPP signal based on the picked-up signal, and provides the LPP signal to an LPP address decoder 321. The LPP address decoder 321 extracts disc positional information (LPP address) from the LPP signal and provides the LPP address information to a timing control circuit 322. In response to a timing signal provided from the timing control circuit 322, an 8-16 modulation circuit 323 modulates the data provided from an external circuit, such as a buffer memory, that is to be recorded. The 8-16 modulation circuit 323 then provides the modulated data to a DVD−R/RW write strategy circuit 324. The DVD−R/RW write strategy circuit 324 converts the modulated data to recording pulses for controlling the output of a DVD−R/RW recording laser. Then, the DVD−R/RW write strategy circuit 324 provides the recording pulses to a write signal gate 325. In response to the timing signal provided from the timing control circuit 322, the write signal gate 325 outputs the recording pulses. In response to a switch control signal, the optical head 310 retrieves the recording pulses via a selector 340, which selectively outputs one of two input signals. The optical head 310 then writes the data to the DVD−R/RW.

The writing of data when the optical disc 301 is DVD+R/RW will now be described. First, a signal picked up by the optical head 310 from the optical disc 301 is provided to a wobble detection circuit 330. The wobble detection circuit 330 generates a wobble signal based on the picked-up signal and provides the wobble signal to an ADIP address decoder 331. The ADIP address decoder 331 extracts disc positional information (ADIP) from the wobble signal and provides the disc positional information to a timing control circuit 332. In response to a timing signal provided from the timing control circuit 332, an 8-16 modulation circuit 333 modulates the data that is to be recorded and provides the modulated data to a DVD+R/RW write strategy circuit 334. The write strategy circuit 334 for DVD+R/RW converts the modulated data to recording pulses for controlling the output of a recording laser for DVD+R/RW and provides the recording pulses to a write signal gate 335. In response to the timing signal provided from the timing control circuit 332, the write signal gate 335 outputs the recording pulses. The optical head 310 receives the recording pulses via the selector 340. The optical head 310 then writes the data to the DVD+R/RW.

In a device that records data to other disc recording media in addition to the DVD−R/RW and the DVD+R/RW, a further exclusively used circuit becomes necessary for each type of disc recording medium. This enlarges the circuit scale (size, number of elements, and number of circuits). Such a problem is not limited to DVD−R/RW and DVD+R/RW and is a common problem to all devices that record data on various types of disc recording media having different recording formats for disc position information, which is in accordance with the data formats.

### SUMMARY OF THE INVENTION

One aspect of the present invention is a data recording control device for controlling recording of data on at least a first disc recording medium of one type and a second recording medium of another type, on which disc positional information, which corresponds to a predetermined data format, is recorded in compliance with a recording format that differs between the disc recording media types. The data recording control device includes a plurality of address decoders including a first address decoder for decoding a reproduction signal of the first disc recording medium and generating disc positional information corresponding to the first disc recording medium, and a second address decoder for decoding a reproduction signal of the second disc recording medium and generating disc positional information corresponding to the second disc recording medium. A first selector, connected to the plurality of address decoders, selects one of the plurality of address decoders in accordance with the type of the disc recording medium. A timing control circuit, connected to the first selector, controls the timing of writing data, based on the disc positional information of the selected address decoder, to the associated disc recording medium.

A further aspect of the present invention is a data recording device capable of recording data to at least a first disc recording medium of one type, to which disc positional information corresponding to a predetermined data format is recorded in compliance with a first recording format, and a second disc recording medium of another type, to which disc positional information is recorded in compliance with a second recording format. The data recording device includes an optical head for irradiating a laser beam on a disc recording medium and picking up information recorded on the disc recording medium. A plurality of address detection circuits including a first address detection circuit, which generates a first reproduction signal based on information picked up from the first disc recording medium, and a second address detection circuit, which generates a second reproduction signal based on information picked up from the second disc recording medium. A data recording control device, connected to the optical head and the plurality of address detection circuits, controls recording of data in accordance with the type of disc recording medium to which data is to be recorded. The data recording control device has a plurality of address decoders including a first address decoder, which decodes the first reproduction signal and generates disc positional information adapted to the first disc recording medium, and a second address decoder, which decodes a reproduction signal of the second disc recording medium and generates disc positional information adapted to the second disc recording medium. A first selector, connected to the plurality of address decoders, selects one of the plurality of address decoders according to the type of the disc recording medium. A timing control circuit, connected to the first selector, controls the timing of writing data, based on the disc positional information of the selected address decoder, to the associated disc recording medium.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a diagram showing the structure of a prior art data recording device for recording data to both DVD−R/RW and DVD+R/RW;

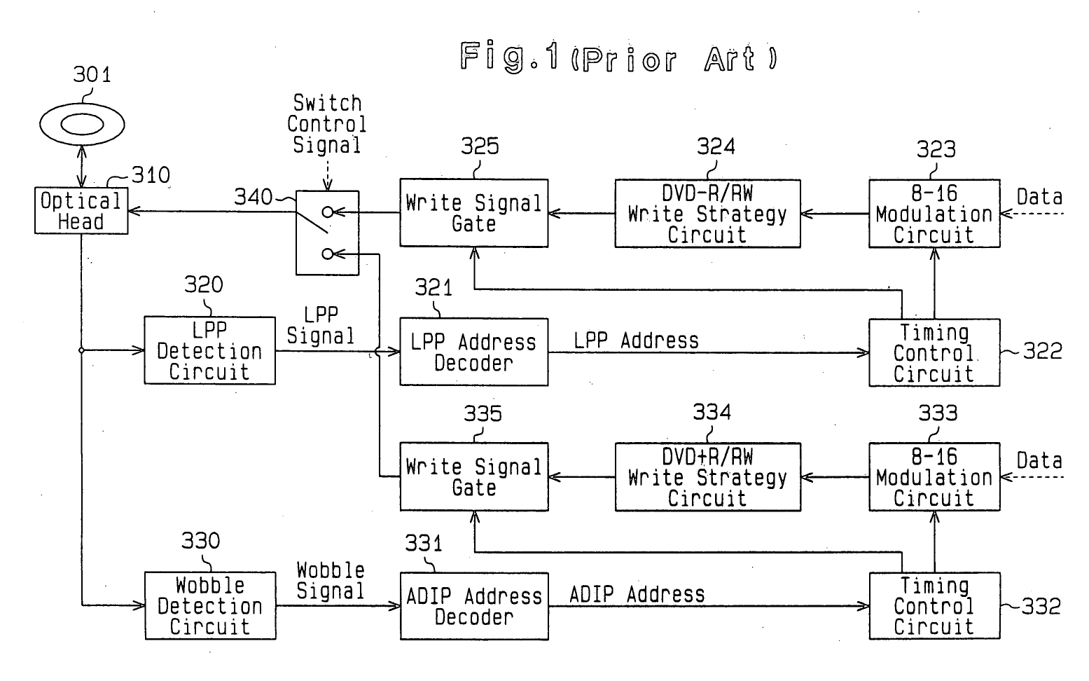

FIG. 2 is a block diagram showing a data recording control device and peripheral circuits thereof according to a first embodiment of the present invention;

FIG. 3 is a block diagram showing a data recording control device and peripheral circuits thereof according to a second embodiment of the present invention; and

FIG. 4 is a diagram showing a format of modulated data of a DVD.

### DETAILED DESCRIPTION OF THE PREFERRED EMBODIMENTS

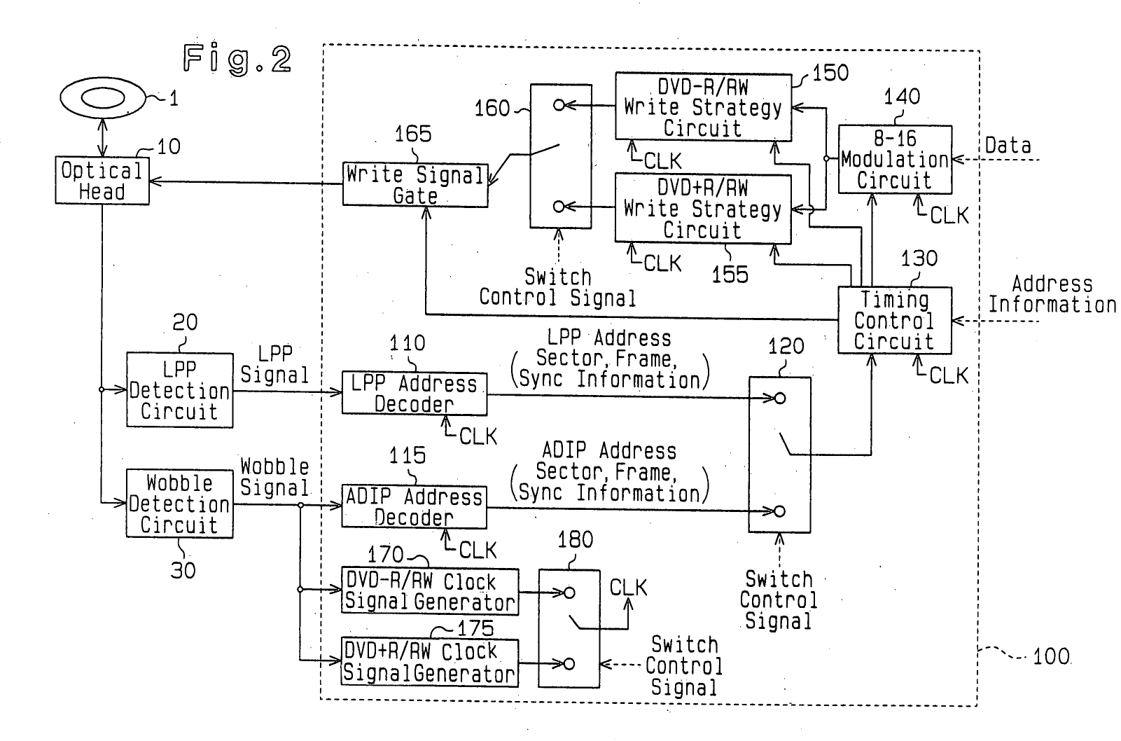

A data recording control device 100 according to a first embodiment of the present invention will now be described. The data recording control device 100 is incorporated in a data recording device that records data to both DVD−R/RW and DVD+R/RW media. FIG. 2 is a block diagram showing the flow of data when the data recording device incorporating the data recording control device 100 records data.

The optical disc 1 is a DVD−R/RW or a DVD+R/RW. The data recording control device 100 receives data from a buffer memory (not shown) and provides recording pulses corresponding to the received data to an optical head 10. The optical head 10 receives the reflection of a reproducing laser beam or a recording laser beam irradiating the optical disc 1. Then, the optical head 10 generates a reproduction signal of the data recorded on the optical disc 1 based on the reflection.

When the optical disc 1 is a DVD−R/RW, an LPP detection circuit 20 generates and outputs an LPP signal from a signal picked up from the optical disc 1 with the optical head 10.

A wobble detection circuit 30 retrieves the signal picked up from the optical disc 1 with the optical head 10 and generates a wobble signal. For example, if the optical disc 1 is a DVD−R/RW, the wobble detection circuit 30 generates the wobble signal based on the wobble formed in the DVD−R/RW. If the optical disc 1 is a DVD+R/RW, the wobble detection circuit 30 generates the wobble signal based on the wobble formed in the DVD+R/RW.

The data recording control device 100 will now be described.

When the optical disc 1 is a DVD−R/RW, the data recording control device 100 recognizes the irradiation position of the laser beam on the optical disc 1 based on the LPP signal provided from the LPP detection circuit 20. More specifically, an LPP address decoder 110 decodes the LPP signal to generate a synchronizing signal, which corresponds to a region where data is recorded in units of frames, and an address signal (LPP address), which represents the data recording region of the optical disc 1 in units of sectors. Thus, when the optical disc 1 is a DVD−R/RW, the LPP address is the signal that represents the irradiation position of the laser beam on the optical disc 1.

When the optical disc 1 is a DVD+R/RW, the data recording control device 100 recognizes the irradiation position of the laser beam on the optical disc 1 based on the wobble signal provided from the wobble detection circuit 30. More specifically, an ADIP address decoder 115 decodes the wobble signal to generate a synchronizing signal, which corresponds to a region where data is recorded in units of frames, or an address signal (ADIP address), which represents the data recording region of the optical disc 1 in units of sectors. Thus, when the optical disc 1 is a DVD+R/RW, the ADIP address is the signal that represents the irradiation position of the laser beam on the optical disc 1.

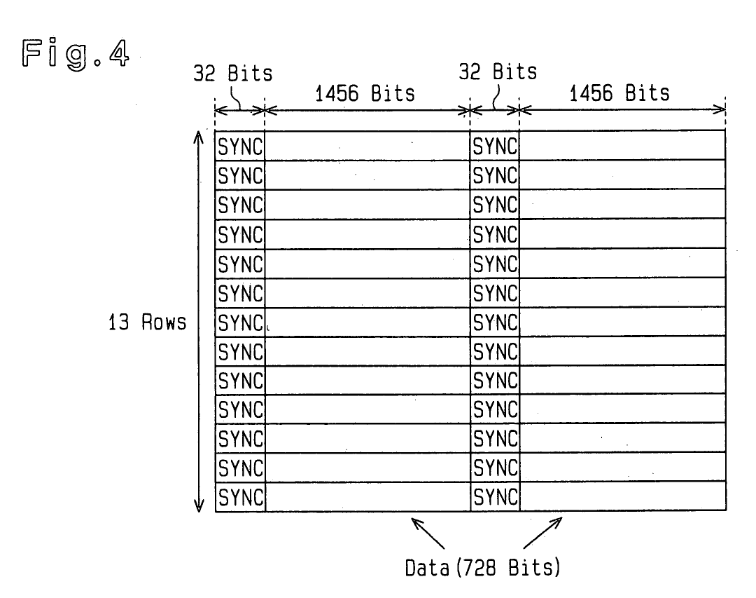

The LPP address and the ADIP address are basically address data of the same data format. In other words, the DVD−R/RW and the DVD+R/RW are discs onto which address data (disc positional information) corresponding to the data format shown in FIG. 4 are recorded with a recording format that differ from each other. However, in the DVD−R/RW and the DVD+R/RW, the same data is obtained when decoding the recorded data.

The address decoder selector 120 selectively outputs either the LPP address or the ADIP address to a timing control circuit 130 in response to a switch control signal.

The timing control circuit 130 detects the irradiation position of the laser beam on the optical disc 1 based on either the LPP address or the ADIP address and controls the timing for controlling data recording.

The circuits of the data recording control device 100 of which operation timings are controlled by the timing control circuit 130 will now be described.

An 8-16 modulation circuit 140 modulates the data provided from an external circuit such as a buffer memory to data having the format shown in FIG. 4. The data encoded in DVD format, regardless of whether the optical disc 1 is a DVD−R/RW or a DVD+R/RW, is modulated to modulated data that is actually recorded on the optical disc 1.

A DVD−R/RW write strategy circuit 150 performs a predetermined pulse conversion on the modulated data provided from the 8-16 modulation circuit 140 to generate recording pulses so that the intensity and irradiation time of the laser beam complies with DVD−R/RW requirements.

A DVD+R/RW write strategy circuit 155 performs a predetermined pulse conversion process on the modulated data provided from the 8-16 modulation circuit 140 to generate recording pulses so that the intensity and irradiation time of the laser beam complies with DVD+R/RW requirements.

Japanese Laid-Open Patent Publication No. 6-313329 and Japanese Laid-Open Patent Publication No. 2000-57571 describes examples of the write strategy circuit 150 and 155.

A write signal gate 165 retrieves the recording pulses generated by either the write strategy circuit 150 or 155 via a pulse selector 160. In other words, in response to the switch control signal, the pulse selector 160 selectively outputs either the recording pulses from the DVD−R/RW write strategy circuit 150 or the DVD+R/RW recording pulses from the write strategy circuit 155 to the write signal gate 165. The write signal gate 165 determines whether to provide the recording pulses to an external device (optical head 10).

The optical head 10 generates a laser beam in accordance with the recording pulses provided from the write signal gate 165 and irradiates the optical disc 1.

Each circuit in the data recording control device 100 operates in accordance with an operation clock signal CLK generated by a DVD−R/RW clock signal generator 170 or a DVD+R/RW clock signal generator 175.

The DVD−R/RW clock signal generator 170 generates an operation clock signal CLK adapted for a DVD−R/RW from the wobble signal of the wobble detection circuit 30. The groove of a DVD−R/RW wobbles at a rate of sixteen cycles for every two frames of the data recording region in the data format. Thus, the operation clock CLK has, for example, “186” pulses for one cycle of the wobble signal. In this case, one pulse of the operation clock CLK corresponds to the time in which the irradiation position of the laser beam on the optical disc 1 moves by one bit of the data recording region.

The DVD+R/RW clock signal generator 175 generates an operation clock signal CLK adapted for a DVD+R/RW from the wobble signal of the wobble detection circuit 30. The groove of a DVD+R/RW wobbles at a rate of 93 cycles for every two frames of the data recording region of the data format. Thus, the operation clock CLK has, for example, “32” pulses for one cycle of the wobble signal. In this case, one pulse of the operation clock CLK corresponds to the time in which the irradiation position of the laser on the optical disc 1 moves by one bit on the data recording region.

The DVD−R/RW clock signal generator 170 and the DVD+R/RW clock signal generator 175 provide the operation clock signal CLK to a clock signal selector 180. In accordance with the switch control signal corresponding to the type of the optical disc 1, the clock signal selector 180 selects either the operation clock signal CLK of the DVD−R/RW clock signal generator 170 or the operation clock signal CLK of the DVD+R/RW clock signal generator 175. The operation clock signal CLK selected in accordance with the type of optical disc 1 is provided to each circuit in the data recording control device 100. Each circuit in the data recording control device 100 thus operates in accordance with the rotation of the optical disc 1.

The recording control performed by the data recording control device 100 when the optical disc 1 is a DVD−R will now be described. The recording control is performed in the same manner when the optical disc 1 is a DVD−RW.

In this case, the clock signal selector 180 selects the operation clock signal CLK generated by the DVD−R/RW clock signal generator 170. The LPP address decoder 110 retrieves the LPP signal, which is generated from the reproduction signal when irradiating the laser beam on the rotation-controlled optical disc 1, and generates the LPP address. The address decoder selector 120, which is switched to select the LPP address, provides the LPP address to the timing control circuit 130.

The address information of the data with which recording starts and address information representing the position (address) on the optical disc 1 from where the data subject to recording should be recorded are input from an external device to the timing control circuit 130. Based on the address information, the timing control circuit 130 controls the 8-16 modulation circuit 140, the DVD−R/RW write strategy circuit 150, and the write signal gate 165. For example, the timing control circuit 130 commands the 8-16 modulation circuit 140 to start modulation at a timing that is earlier than the timing at which the irradiation position of the laser reaches the desired position for starting recording by the sum of the time required for modulation, the time required for generation of the recording pulses, and a predetermined margin time. Furthermore, the timing control circuit 130 commands the 8-16 modulation circuit 140 and the DVD−R/RW write strategy circuit 150 to wait in a state in which the recording pulses that are required to be actually recorded are held in the DVD−R/RW write strategy circuit 150 until the irradiation position of the laser reaches the desired position for starting recording.

Thus, when the 8-16 modulation circuit 140 completes modulation and when the DVD−R/RW write strategy circuit 150 completes converting modulated data to recording pulses, the irradiation position of the laser is ahead of the position desired for recording. The 8-16 modulation circuit 140, the DVD−R/RW write strategy circuit 150, and the write signal gate 165 are activated at the timing in which the irradiation position of the laser reaches the desired position. The pulse selector 160 is switched in advance by the switch control signal to provide the output of the DVD−R/RW write strategy circuit 150 to the write signal gate 165.

When starting data recording from the middle of the recording pulses generated by the DVD−R/RW write strategy circuit 150, recording pulses that are not required to be recorded are provided to the write signal gate 165 but are not written to the optical disc 1 because the timing control circuit 130 prohibits output thereof via the write signal gate 165.

The recording control performed by the data recording control device 100 when the optical disc 1 is a DVD+R will now be described. The recording control is performed in the same manner when the optical disc 1 is a DVD+RW.

In this case, the clock signal selector 180 selects the operation clock signal CLK generated by the DVD+R/RW clock signal generator 175. The ADIP address decoder 115, which retrieves the wobble signal generated from the reproduction signal by irradiating the laser beam to the rotation-controlled optical disc 1, and generates the ADIP address. The address decoder selector 120, which is switched to select the ADIP address, provides the ADIP address to the timing control circuit 130.

The timing control circuit 130 controls the 8-16 modulation circuit 140, the DVD+R/RW write strategy circuit 155, and the write signal gate 165 in a mode corresponding to the control of the DVD−R in accordance with the address information of the data from which recording starts. In this manner, the same timing control circuit 130 is used when controlling the recording of data to various types of optical discs 1. This reduces the circuit scale (size, number of elements, number if circuits).

The first embodiment of the present invention has the following advantages.

(1) The data recording control device 100 includes the address decoder selector 120 for selecting either the LPP address output from the LPP address decoder 110 or the ADIP address output from the ADIP address decoder 115. Thus, when recording data to the optical disc 1, the same timing control circuit 130 is used when the optical disc 1 is a DVD−R/RW and when the optical disc 1 is a DVD+R/RW. This reduces the circuit scale of the data recording control device 100.

(2) The data recording control device 100 includes the pulse selector 160 for selecting either the recording pulses output from the DVD−R/RW write strategy circuit 150 or the recording pulses output from the DVD+R/RW write strategy circuit 155. Thus, the same write signal gate 165 is used when the optical disc is a DVD−R/RW and when the optical disc 1 is a DVD+R/RW. This reduces the circuit scale of the data recording control device 100.

A data recording control device 200 according to a second embodiment of the present invention will now be described focusing on the differences with the first embodiment. The data recording control device 200 is incorporated in a data recording device capable of recording data to both a DVD−R/RW and a DVD+R/RW.

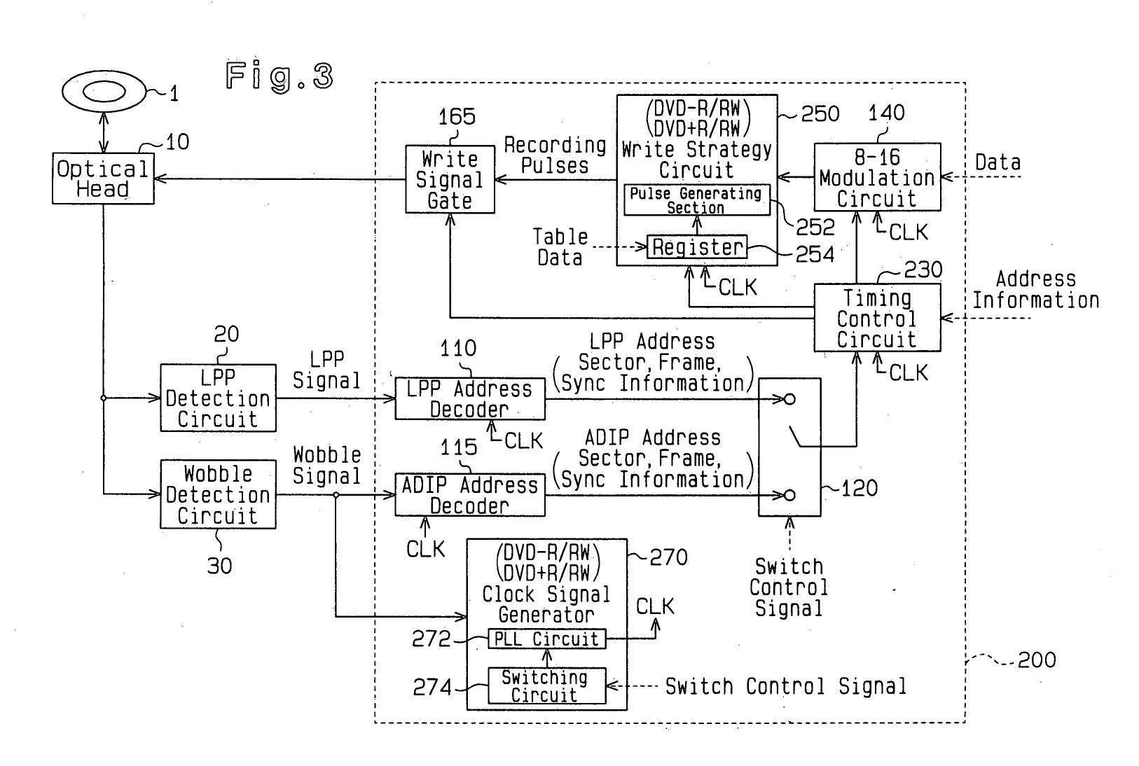

The first embodiment employs the DVD−R/RW write strategy circuit 150, the DVD+R/RW write strategy circuit 155, and the pulse selector 160, which selects the recording pulses generated by either the write strategy circuit 150 or the write strategy circuit 155. The second embodiment employs a single write strategy circuit 250 that generates recording pulses for a DVD−R/RW and recording pulses for a DVD+R/RW, as shown in FIG. 3.

The write strategy circuit 250 includes a pulse generating section 252, which generates recording pulses from modulated data, and a register 254, which stores table data for setting the generation mode of the recording pulses generated by the pulse generating section 252 that differ between the types (DVD−R/RW or DVD+R/RW) of the optical disc 1.

The pulse generating section 252 modulates each piece of modulated data and generates one or more recording pulses. The pulse width, the edge, and the pulse height value of each recording pulse, and the number of recording pulses are variable parameters determined in accordance with the modulated data.

The register 254 stores table data for setting the pulse modulation mode for modulating the modulated data to produce recording pulses in correspondence with the type of the optical disc 1. Therefore, the table data is used to determine the variable parameters in response to the modulated data. The table data is written to the register 254 by a microcomputer (not shown), which controls each part of the data recording device, in accordance with the type of the optical disc 1.

The pulse generating section 252 computes and generates the recording pulses based on the modulated data and the table data stored in the register 254.

The operation clock signal CLK used when recording data to the DVD−R/RW or the DVD+R/RW is generated by a single clock signal generator 270. More specifically, the clock signal generator 270 includes a PLL circuit 272, which generates a clock signal based on the wobble signal, and a switching circuit 274, which switches the generation mode of the clock of the PLL circuit 272 in accordance with the switch control signal input from an external device.

When a switch control signal designating the operation clock signal for a DVD−R/RW is received, the clock signal generator 270 controls the PLL circuit 272 so as to generate an operation clock CLK having, for example, “186” pulses for every one cycle of the wobble signal. When a switch control signal designating the operation clock signal for a DVD+R/RW is received, the clock signal generator 270 controls the PLL circuit 272 so as to generate an operation clock CLK having, for example, “32” pulses for every one cycle of the wobble signal. One pulse of the operation clock signal CLK generated in this manner corresponds to the time in which the irradiation position of the laser beam on the optical disc 1 moves by one bit of the data recording region irrespective of the type of the optical disc 1.

The second embodiment of the present invention has the following advantages.

(3) The data recording control device 200 has the write strategy circuit 250, which includes the pulse generating section 252 for generating the recording pulse based on the modulated data, and the register 254, which stores the table data for setting the generation mode of the recording pulses generated from the pulse generating section 252 in accordance with the type (DVD−R/RW and DVD+R/RW) of the optical disc 1. Thus, the same pulse generating section 252 is used when the optical disc 1 is a DVD−R/RW and when the optical disc 1 is a DVD+R/RW. This reduces the circuit scale of the data recording control device 200.

(4) In the data recording control device 200, the clock signal generator 270 generates an operation clock signal CLK adapted to record data on both a DVD−R/RW and a DVD+R/RW. This reduces the circuit scale of the data recording control device.

It should be apparent to those skilled in the art that the present invention may be embodied in many other specific forms without departing from the spirit or scope of the invention. Particularly, it should be understood that the present invention may be embodied in the following forms.

The operation clock signal CLK does not necessarily have to be generated based on the wobble signal. For example, in the data recording control for DVD−R/RW media, the operation clock signal CLK may be generated from the LPP signal.

The operation clock signal CLK does not necessarily have to be generated based on the reflection signal of the laser beam irradiated on the rotation-controlled optical disc 1. The operation clock signal CLK may be a clock signal generated by, for example, an oscillator such as a crystal oscillator. In this case, the rotating movement of the optical disc 1 is controlled in association with the crystal oscillator.

In the second embodiment, the same pulse generating section 252, which generates both the pulse width and the pulse height value of the recording pulses, is used to control recording for a DVD−R/RW and a DVD+R/RW. However, a circuit for generating only one of either the pulse width or the pulse height value, for example, may be used to control recording for both a DVD−R/RW and a DVD+R/RW.

The timing control circuits 130 and 230 do not necessarily have to control the operation timing of the 8-16 modulation circuit 140, the write strategy circuits 150, 155, and 250, and the write signal gate 165. For example, in a data recording control device that does not have, for example, the write signal gate 165 (gate circuit), the timing control circuits 130 and 230 may control only the 8-16 modulation circuit 140 and the write strategy circuits 150, 155, and 250. Furthermore, when a data recording control device does not have the 8-16 modulation circuit 140, the timing control circuits 130 and 230 may control only the write strategy circuits 150, 155, and 250. Alternatively, the timing control circuits 130 and 230 may control only the write strategy circuits 150, 155, and 250 and the write signal gate 165 (gate circuit).

The configuration of the data recording control device is not limited to the embodiments and modifications described herein and may be suitably modified as long as the same timing control circuit is used when the optical disc 1 is a DVD−R/RW and when the optical disc 1 is a DVD+R/RW.

The optical disc is not limited to a DVD−R/RW or a DVD+R/RW. In short, the same timing control circuit is used for two or more different types of disc recording media with disc positional information, which corresponds to address information of data complying with a predetermined data format, recorded with different recording formats.

The register 254 can be a memory device, such as a RAM or a ROM.

Therefore, the present examples and embodiments are to be considered as illustrative and not restrictive and the invention is not to be limited to the details given herein, but may be modified within the scope and equivalence of the appended claims.

What is claimed is:

1. A data recording control device for controlling recording of data on at least a first disc recording medium of one type and a second recording medium of another type, on which disc positional information, which corresponds to a predetermined data format, is recorded in compliance with a recording format that differs between the disc recording media types, the data recording control device comprising:
a plurality of address decoders including a first address decoder for decoding a reproduction signal of the first disc recording medium and generating disc positional information corresponding to the first disc recording medium, and a second address decoder for decoding a reproduction signal of the second disc recording medium and generating disc positional information corresponding to the second disc recording medium;
a first selector, connected to the plurality of address decoders, for selecting one of the plurality of address decoders in accordance with the type of the disc recording medium; and
a timing control circuit, connected to the first selector, for controlling the timing of writing data, based on the disc positional information of the selected address decoder, to the associated disc recording medium.

2. The data recording control device as claimed in claim 1, further comprising:
a modulation circuit, connected to the timing control circuit, for performing a predetermined modulation on data that is to be recorded to generate modulated data;
a plurality of write strategy circuits, connected to the modulation circuit, for generating a recording pulse that controls output of a recording laser beam irradiated on the disc recording medium based on the modulated data, the plurality of write strategy circuits including a first write strategy circuit for generating a recording pulse for the first disc recording medium and a second write strategy circuit for generating a recording pulse for the second recording medium; and
a second selector for selecting one of the plurality of write strategy circuits.

3. The data recording control device as claimed in claim 2, further comprising:
a gate circuit, connected to the timing control circuit, for outputting the recording pulse generated by the selected write strategy circuit in response to a command from the timing control circuit.

4. The data recording control device as claimed in claim 2, wherein the timing control circuit controls the modulation circuit and the first write strategy circuit at a timing adapted to the first disc recording medium when recording data to the first disc recording medium, and controls the modulation circuit and the second write strategy circuit at a timing adapted to the second disc recording medium when recording data to the second disc recording medium.

5. The data recording control device as claimed in claim 1, further comprising:
a modulation circuit, connected to the timing control circuit, for performing a predetermined modulation on the data that is to be recorded to generate modulated data; and
a write strategy circuit, connected to the modulation circuit, for generating a recording pulse that controls an output of a recording laser beam corresponding to each type of the disc recording medium based on the modulated data.

6. The data recording control device as claimed in claim 5, wherein the write strategy circuit includes:
a pulse generating section for generating the recording pulse based on the modulated data; and
a register, connected to the pulse generating section, for storing table data that sets a generation mode for the recording pulse corresponding to the type of the disc recording media.

7. The data recording control device as claimed in claim 5, wherein the write strategy circuit generates a recording pulse adapted to the type of the disc recording medium to which data is to be recorded.

8. The data recording control device as claimed in claim 5, further comprising:
a gate circuit, connected to the timing control circuit, for outputting the recording pulse in response to a command from the timing control circuit.

9. The data recording control device as claimed in claim 5, wherein the timing control circuit controls the modulation circuit and the write strategy circuit at a timing adapted to the first disc recording medium when recording data to the first disc recording medium, and controls the modulation circuit and the write strategy circuit at a timing adapted to the second disc recording medium when recording data to the second disc recording medium.

10. The data recording control device as claimed in claim 1, further comprising:
a plurality of clock signal generators for generating, from the reproduction signals of the various types of disc recording media, a plurality of clock signals for recording data to the types of disc recording media.

11. The data recording control device as claimed in claim 10, wherein the plurality of clock signal generators includes a first clock generator, which generates a clock signal used to record data to the first disc recording medium based on the reproduction signal of the first disc recording medium, and a second clock generator, which generates a clock signal used to record data to the second recording medium based on the reproduction signal of the second recording medium.

12. The data recording control device as claimed in claim 1, further comprising:
a clock signal generator for generating a clock signal adapted to record data on any one of the types of disc recording media, the clock signal generator generating the clock signal based on the reproduction signal of the disc recording medium to which data is to be recorded.

13. The data recording control device as claimed in claim 1, further comprising:
a clock signal generator for generating a plurality of clock signals for recording data on the types of disc recording media, the clock signal generator generating a clock signal adapted to the type of disc recording medium based on the reproduction signal of the disc recording medium to which data is to be recorded.

14. The data recording control device as claimed in claim 1, wherein:
the disc positional information of the first disc recording medium is recorded in a land pre-pit formed at a predetermined interval along a recording track; and
the disc positional information of the second disc recording medium is recorded in a wobble of a groove formed along a recording track.

15. A data recording device capable of recording data to at least a first disc recording medium of one type, to which disc positional information corresponding to a predetermined data format is recorded in compliance with a first recording format, and a second disc recording medium of another type, to which disc positional information is recorded in compliance with a second recording format, the data recording device comprising:
an optical head for irradiating a laser beam on a disc recording medium and picking up information recorded on the disc recording medium;
a plurality of address detection circuits including a first address detection circuit, which generates a first reproduction signal based on information picked up from the first disc recording medium, and a second address detection circuit, which generates a second reproduction signal based on information picked up from the second disc recording medium; and
a data recording control device, connected to the optical head and the plurality of address detection circuits, for controlling recording of data in accordance with the type of disc recording medium to which data is to be recorded, the data recording control device including:
a plurality of address decoders including a first address decoder, which decodes the first reproduction signal and generates disc positional information adapted to the first disc recording medium, and a second address decoder, which decodes a reproduction signal of the second disc recording medium and generates disc positional information adapted to the second disc recording medium;
a first selector, connected to the plurality of address decoders, for selecting one of the plurality of address decoders according to the type of the disc recording medium; and
a timing control circuit, connected to the first selector, for controlling the timing of writing data, based on the disc positional information of the selected address decoder, to the associated disc recording medium.
